(19) United States
(12) Patent Application Publication
(10) Pub. No.: US 2004/0100112 A1
(43) Pub. Date: May 27, 2004

(54) Anchor arrangement for securing an infant seat

(76) Inventors: D. Scott Bittinger, Fenton, MI (US); Jere R. Lansinger, Bloomfield Hills, MI (US)

Correspondence Address: Ralph E. Smith, DaimlerChrysler Intellectual Capital Corporation, CIMS 483-02-19, 800 Chrysler Drive, Auburn Hills, MI, 48326-2757, US

(21) Appl. No.: 10/306,348

(22) Filed: Nov. 26, 2002

(51) Int. Cl. B60N 2/01

(52) U.S. Cl. 296/64

(57) ABSTRACT

A vehicle cabin is provided, the cabin including at least one passenger seat and an anchor arrangement configured to detachably couple to a rearwardly facing infant seat situated on the passenger seat, in which the anchor arrangement prevents the rearwardly facing infant seat from accelerating toward a rear of a vehicle.

### FIELD OF THE INVENTION

The present invention relates to an anchor arrangement for securing an infant seat to a vehicle passenger seat.

### BACKGROUND INFORMATION

It is believed that the use of infant seats for children, for example, in automobiles, is well known. These infant seats may be secured to a front passenger seat and/or a rear passenger seat via an attachment mechanism, for example, a tether or a seat-buckle strap. Once attached, an infant may be placed in the infant seat and subsequently secured for safety.

Referring to FIG. 1, there is seen a vehicle 100 having a vehicle cabin 101. The cabin 101 includes front and rear passenger seats 105f, 105r, as well as an infant seat 110 detachably secured to the front passenger seat 105f, for example, by strap 120 and/or tether 115.

However, it is believed that the above arrangement for fastening the infant seat 110 to the vehicle 100 may endanger the infant (not shown) if used in automobiles having a passenger side air-bag, such as passenger side air-bag 125 illustrated in FIG. 1. Passenger side air-bag 125, when deployed, may strike the infant situated within the infant seat 110, thereby possibly causing bodily injury.

To prevent the infant from being injured, it is known to provide the automobile 100 with an occupant sensing arrangement (not shown) for detecting the type of occupant seated in the front passenger seat 105f. If the sensing arrangement determines that the occupant is an infant situated in an infant seat, the sensing system may, for example, deactivate an air-bag deployment system, such that the air-bag 125 will not deploy in the event of a vehicle impact, thereby sparing the infant from air-bag related injuries.

To determine the type of occupant, the sensing arrangement (not shown) may, for example, weigh the occupant in the front passenger seat 105f to infer occupant information. If the weight of the occupant in the front passenger seat 105f is within a certain range, for example, between 0 and 21 kg, the sensing arrangement may, for example, infer that the occupant situated in the front passenger seat 105f is an infant in an infant seat. In this manner, the sensing arrangement may, for example, deactivate the air-bag deployment system.

However, it is believed that sensing arrangements of the type described above may be disadvantageous with respect to infants seated in the front passenger seat 105, in that these sensing arrangements may incorrectly infer the type of occupant seated in the front passenger seat 105f. For example, if the infant is unusually heavy or if additional packages are placed on the front passenger seat 105f (e.g., groceries), the sensing arrangement may incorrectly infer that the occupant is an adult or is otherwise not situated in an infant seat. In this case, the sensing arrangement may fail to deactivate the air-bag deployment system. Thus, the passenger side air-bag 125, when deployed, may strike the infant situated within the infant seat 110, thereby possibly causing bodily injury.

As an alternative, therefore, the infant seat 110 may be arranged in a rearwardly facing direction as shown in FIG. 2. As shown in FIG. 2, the rearwardly facing infant seat (RFIS) is attached to the front passenger seat 105f via strap 120. In this manner, the back 205 of infant seat 110 may protect an infant (not shown) from injury caused by the deployment of air-bag 125.

However, it is believed that this arrangement of the RFIS 110 is disadvantageous in that the RFIS 110 may pivot rearwardly in the direction of arrow 305 if the vehicle 100 is struck from behind or if a deploying air-bag 125 strikes the RFIS 110, as shown in FIG. 3. In this manner, an infant (not shown) situated within the infant seat 110 may be accelerated against the seat back 310 of the front passenger seat 105f, thereby possibly causing bodily injury.

To help prevent bodily injury caused by the arrangements described above, it is well known to place the infant seat 110 in the rear vehicle seat 105r. Referring now to FIG. 4, there is seen a forward facing infant seat 110 situated on the rear passenger seat 105r of vehicle 100. Infant seat 110 may be secured to rear passenger seat 105r, for example, by strap 120 and/or tether 115 fixedly secured to anchor point 405. In this manner, rear passenger seat 105r may prevent rearward motion of the infant seat 110, while the strap 120 and/or tether 115 may prevent forward motion of the infant seat 110.

### SUMMARY OF THE INVENTION

It is an object of the present invention to provide a vehicle cabin, including at least one passenger seat; and an anchor arrangement configured to detachably couple to a rearwardly facing infant seat situated on the passenger seat; wherein the anchor arrangement prevents the rearwardly facing infant seat from accelerating toward a rear of a vehicle.

It is another object of the present invention to provide the vehicle cabin described above, in which the at least one passenger seat includes a front passenger seat.

It is still another object of the present invention to provide the vehicle cabin described above, in which the anchor arrangement includes at least one anchor point configured to detachably couple to a tether, the tether being coupled to the rearwardly facing infant seat.

It is yet another object of the present invention to provide the vehicle cabin described above, in which the at least one anchor point includes a wire.

It is still another object of the present invention to provide the vehicle cabin described above, in which the wire has a diameter of approximately 6 millimeters.

It is yet another object of the present invention to provide the vehicle cabin described above, in which the anchor arrangement is arranged on at least one of a dash board, a floor of the vehicle, and the at least one passenger seat.

It is still another object of the present invention to provide the vehicle cabin described above, in which the anchor arrangement exhibits at least one function other than preventing the rearwardly facing infant seat from accelerating toward the rear of the vehicle.

It is yet another object of the present invention to provide the vehicle cabin described above, in which the anchor arrangement includes at least one grab handle.

It is still another object of the present invention to provide the vehicle cabin described above, in which the anchor arrangement includes a detection arrangement configured to detect if the anchor arrangement is detachably coupled to the rearwardly facing infant seat.

It is yet another object of the present invention to provide the vehicle cabin described above, further including at least one vehicle system; in which the detection arrangement is configured to communicate a signal to the vehicle system if the detection arrangement detects that the anchor arrangement is detachably coupled to the rearwardly facing infant seat.

It is still another object of the present invention to provide the vehicle cabin described above, in which the at least one vehicle system includes an air-bag deployment system.

It is yet another object of the present invention to provide the vehicle cabin described above, in which the air-bag deployment system is configured to prevent a deployment of an air-bag if the detection arrangement detects that the anchor arrangement is detachably coupled to the rearwardly facing infant seat.

### BRIEF DESCRIPTION OF THE DRAWINGS

FIG. 1 illustrates a vehicle having a vehicle cabin.

FIG. 2 illustrates the vehicle of FIG. 1, in which an infant seat is arranged in a rearwardly facing direction.

FIG. 3 illustrates the vehicle of FIG. 2, in which the infant seat has been struck by a deploying air-bag.

FIG. 4 illustrates the vehicle of FIG. 1, in which an infant seat is arranged on a rear passenger seat.

FIG. 5a illustrates a first exemplary RFIS anchor arrangement according to the present invention.

FIG. 5b illustrates a second exemplary RFIS anchor arrangement according to the present invention.

FIG. 5c illustrates a third exemplary RFIS anchor arrangement according to the present invention.

FIG. 6 illustrates an exemplary attachment arrangement according to the present invention.

FIG. 7 illustrates an exemplary multi-functional anchor point according to the present invention.

FIG. 8 illustrates an exemplary anchor arrangement according to the present invention.

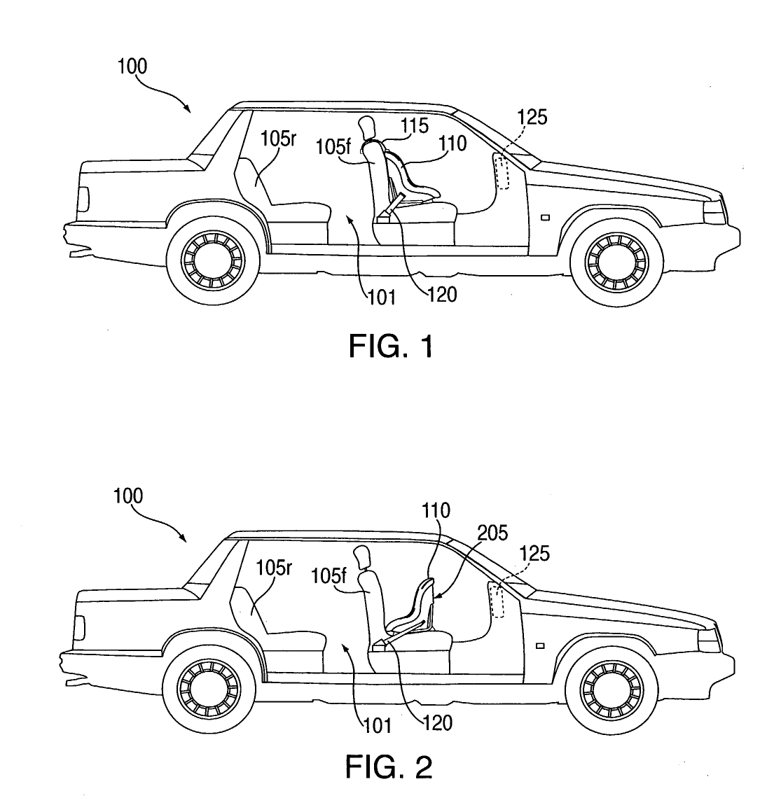

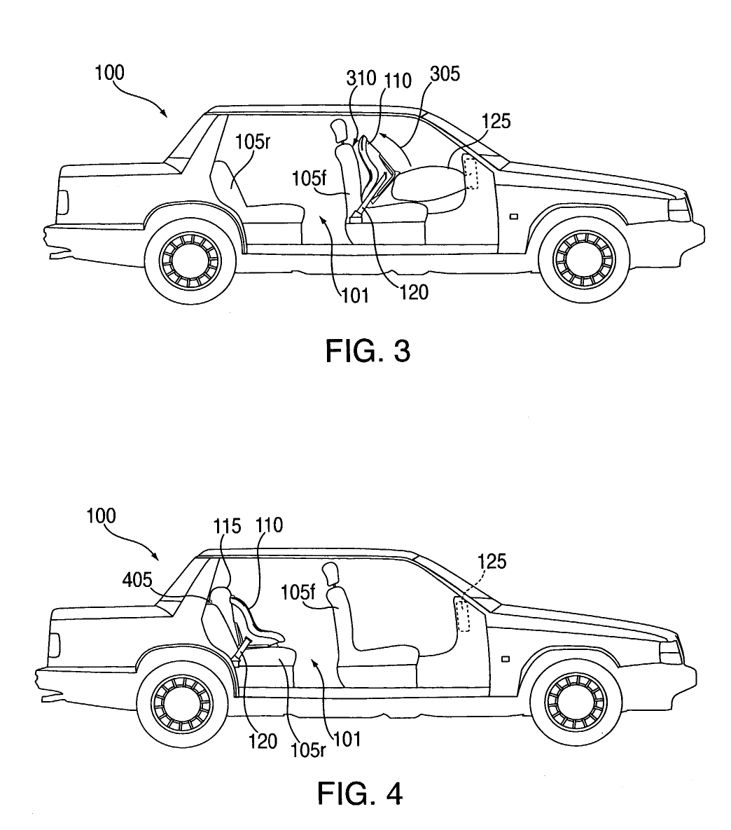

### DETAILED DESCRIPTION

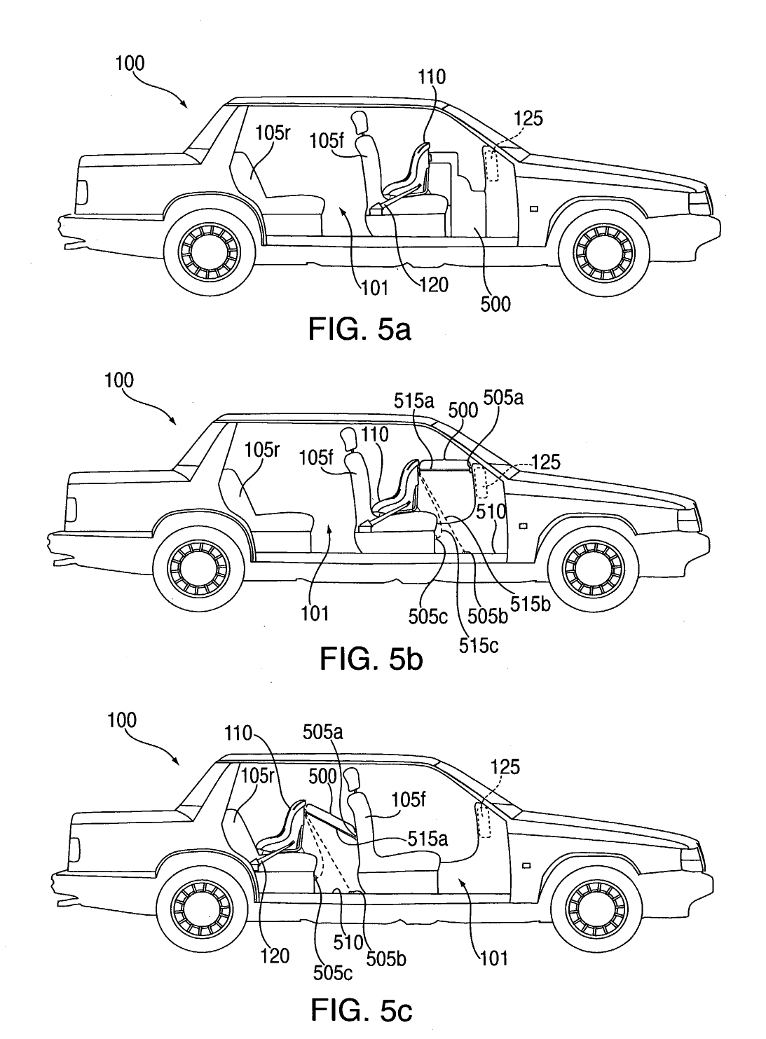

Referring now to FIG. 5a, there is seen a first exemplary RFIS anchor arrangement 500 configured to detachably couple to a rearwardly facing infant seat 110 situated, for example, on the front passenger seat 105f. RFIS anchor arrangement 500 is operable to prevent the RFIS 110 from accelerating toward the rear of a vehicle during a rear vehicle impact and/or a deployment of a passenger side air-bag deployment 125.

Referring now to FIG. 5b, there is seen a second exemplary RFIS anchor arrangement 500 including at least one anchor point 505 configured to detachably couple to an attachment arrangement 515, for example, a tether, the attachment arrangement 515 being coupled to the RFIS 110. It should be appreciated that anchor point 505 may include any arrangement operable to detachably couple to an attachment arrangement 515, such as, for example, a wire having a diameter of, for example, approximately 6 mm.

As shown in FIG. 5b, for example, anchor point 505 may be situated on the dashboard (505a), on the floor 510 of the vehicle 100 (505b), and/or on the front passenger seat 105f (505c). Although FIG. 5b shows anchor arrangement 500 including a single attachment arrangement 515a, it should be appreciated that anchor arrangement 500 may include at least one additional attachment arrangement, for example, attachment arrangements 515b, 515c, configured to detachably couple to at least one of anchor points 505b, 505c.

Once the RFIS 110 is properly secured, the back 205 of the RFIS 110 protects an infant (not shown) from the deployment of the passenger side air-bag 125, while the exemplary anchor arrangement 500 prevents the RFIS 110 from accelerating rearwardly towards the seat-back 310 of the front passenger seat 105f.

Referring now to FIG. 5c, there is seen a third exemplary RFIS anchor arrangement 500 configured to secure a RFIS 110 to the rear passenger seat 105r. As shown in FIG. 5c, anchor arrangement 500 includes at least one anchor point 505 configured to detachably couple to an attachment arrangement 515, for example, a tether, the attachment arrangement 515 being coupled to the RFIS 110. As shown in FIG. 5c, for example, anchor point 505 may be situated on the back of the front passenger seat 105f (505a), on the floor 510 of the vehicle 100 (505b), and/or on the rear passenger seat 105r (505c). Although FIG. 5c shows anchor arrangement 500 including a single attachment arrangement 515a, it should be appreciated that anchor arrangement 500 may include at least one additional attachment arrangement, for example, attachment arrangements 515b, 515c, configured to detachably couple to at least one of anchor points 505b, 505c.

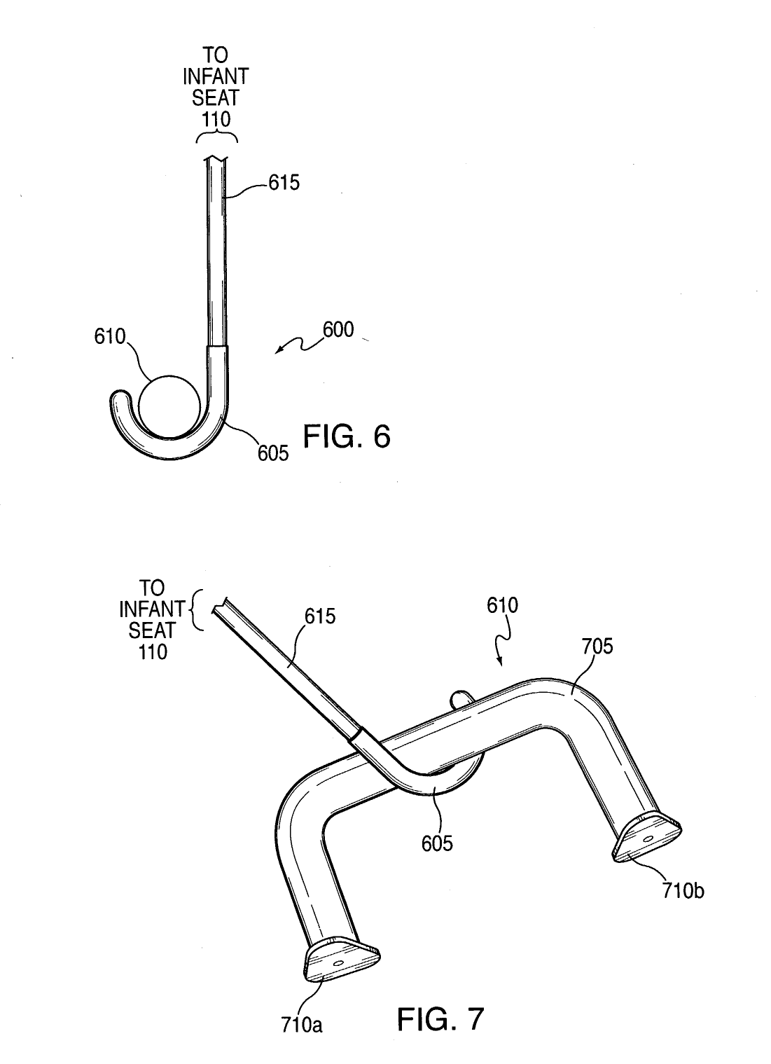

Referring to FIG. 6, there is seen an exemplary attachment arrangement 600 for fixedly securing the RFIS 110 to the vehicle 100. The attachment arrangement 600 includes tether 615 connected to tether hook 605, which is configured to detachably engage with anchor point 610. As described above with reference to FIGS. 5a-5c, anchor point 610 may be situated on the dashboard, on the floor 510 of the vehicle 100, on the front passenger seat 105f, and/or on the rear passenger seat 105r.

In accordance with another exemplary embodiment of the present invention, the anchor point 610 may exhibit at least one function other than preventing the rearwardly facing infant seat from accelerating toward the rear of the vehicle.

Referring now to FIG. 7, there is seen a fourth exemplary embodiment according to the present invention, in which the anchor point 610 also functions as a grab handle 705 rotatably secured to the vehicle 100 via brackets 710a, 710b. As shown in FIG. 7, the tether 615 connects to the tether hook 605, which may detachably engage the grab handle 705 to help secure a RFIS 110. Alternatively, in situations in which a RFIS 110 is not used, for example, if the owner (not shown) of the automobile 100 has no children, an occupant (not shown) may use the grab handle 705 to help enter and/or exit the vehicle, by grasping the grab handle 705 for better balance.

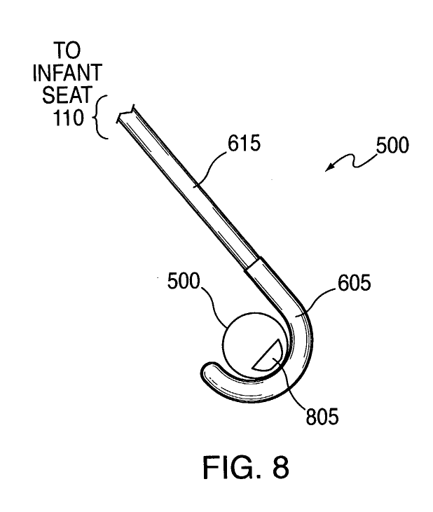

Referring to FIG. 8, there is seen another exemplary embodiment according to the present invention. As shown in FIG. 8, attachment arrangement 515 includes tether 615 connected to tether hook 605, which is configured to detachably couple to anchor point 610. In the exemplary embodiment illustrated in FIG. 8, anchor arrangement 500 includes a detection arrangement 805 configured to detect if the anchor arrangement 500 is detachably coupled to the RFIS 110 via attachment arrangement 515. For this purpose, detection arrangement 805 may include, for example, electrical circuitry operable to communicate a signal to at least one vehicle system, for example, an air-bag deployment system, if the detection arrangement 805 detects that the anchor arrangement 500 is detachably coupled to the RFIS via attachment arrangement 515. If so, the vehicle system may, for example, perform a function in accordance with the signal, such as preventing the deployment of passenger side air-bag 125.

What is claimed is:

1. A vehicle cabin, comprising:
at least one passenger seat; and
an anchor arrangement configured to detachably couple to a rearwardly facing infant seat situated on the passenger seat; wherein the anchor arrangement prevents the rearwardly facing infant seat from accelerating toward a rear of a vehicle.

2. The vehicle cabin according to claim 1, wherein the at least one passenger seat includes a front passenger seat.

3. The vehicle cabin according to claim 1, wherein the anchor arrangement includes at least one anchor point configured to detachably couple to a tether, the tether being coupled to the rearwardly facing infant seat.

4. The vehicle cabin according to claim 3, wherein the at least one anchor point includes a wire.

5. The vehicle cabin according to claim 4, wherein the wire has a diameter of approximately 6 millimeters.

6. The vehicle cabin according to claim 1, wherein the anchor arrangement is arranged on a dash board of the vehicle.

7. The vehicle cabin according to claim 1, wherein the anchor arrangement is arranged on a floor of the vehicle.

8. The vehicle cabin according to claim 1, wherein the anchor arrangement is arranged on at least one passenger seat.

9. The vehicle cabin according to claim 1, wherein the anchor arrangement includes at least one anchor point configured to detachably couple to a tether, the tether being coupled to the rearwardly facing infant seat.

10. The vehicle cabin according to claim 1, wherein the anchor arrangement exhibits at least one function other than preventing the rearwardly facing infant seat from accelerating toward the rear of the vehicle.

11. The vehicle cabin according to claim 10, wherein the anchor arrangement includes at least one grab handle.

12. The vehicle cabin according to claim 1, wherein the anchor arrangement includes a detection arrangement configured to detect if the anchor arrangement is detachably coupled to the rearwardly facing infant seat.

13. The vehicle cabin according to claim 12, further comprising:
at least one vehicle system; wherein the detection arrangement is configured to communicate a signal to the vehicle system if the detection arrangement detects that the anchor arrangement is detachably coupled to the rearwardly facing infant seat.

14. The vehicle cabin according to claim 13, wherein the at least one vehicle system includes an air-bag deployment system.

15. The vehicle cabin according to claim 14, wherein the air-bag deployment system is configured to prevent a deployment of an air-bag if the detection arrangement detects that the anchor arrangement is detachably coupled to the rearwardly facing infant seat.

16. The vehicle cabin according to claim 1, wherein the anchor arrangement prevents the rearwardly facing infant seat from pivoting toward the rear of the vehicle.

17. A vehicle cabin, comprising:
at least one passenger seat; and
means for preventing a rearwardly facing infant seat situated on the passenger seat from accelerating toward a rear of a vehicle.

18. The vehicle cabin according to claim 17, wherein the at least one passenger seat includes a front passenger seat.
